(19) United States
(12) Patent Application Publication
(10) Pub. No.: US 2016/0350475 A1
(43) Pub. Date: Dec. 1, 2016

(54) Method for Developing and Applying Databases for Idenfication of Microorganisms by MALDI-TOF Mass Spectrometry

(71) Applicant: Virgin Instruments Corporation, Marlborough, MA (US)

(72) Inventors: Marvin L. Vestal, Framingham, MA (US); Kenneth Parker, Hopkinton, MA (US)

(73) Assignee: Virgin Instruments Corporation, Marlborough, MA (US)

(21) Appl. No.: 15/164,440

(22) Filed: May 25, 2016

Related U.S. Application Data
(60) Provisional application No. 62/168,562, filed on May 29, 2015.

(51) Int. Cl. G06F 19/18; C40B 30/02; G06F 19/28; G06F 19/24; H01J 49/16; H01J 49/00

(52) U.S. Cl. CPC G06F 19/18; H01J 49/164; H01J 49/0036; G06F 19/28; G06F 19/24; C40B 30/02; H01J 49/40

(57) ABSTRACT

A method for organism identification using MALDI TOF mass spectrometry includes generating a searchable database. A mass spectrum is acquired from a sample. Peak detection of the acquired mass spectrum is performed, binned, and a vector is generated. Dot products are computed between the generated vector of peak detected mass spectrum and averaged binned spectrum for each isolate. A relative probability that acquired mass spectrum matches a spectrum from each isolate in the searchable database is computed. A logarithmic score for matching the acquired mass spectrum with the mass spectrum is computed from each isolate. The logarithmic score for matching the acquired mass spectrum is compared with the mass spectrum from each isolate to a predetermined minimum passing score. A list of isolates is generated with greater than the predetermined minimum score. The probability rank and logarithmic score are then reported for each isolate with a minimum passing score.

### CROSS REFERENCE TO RELATED APPLICATION

The present application is a non-provisional application of U.S. Provisional Patent Application No. 62/168,562 entitled “Method for Developing and Applying Databases for Identification of Microorganisms by MALDI-TOF Mass Spectrometry” filed on May 29, 2015. The entire contents of U.S. Provisional Patent Application No. 62/168,562 are herein incorporated by reference.

The section headings used herein are for organizational purposes only and should not to be construed as limiting the subject matter described in the present application in any way.

### INTRODUCTION

Three commercial protein databases have been developed for microbial identification by MALDI mass spectrometry by protein profiling. Two companies, Bruker Corporation and BioMérieux Inc. have received European ‘C’ mark and U.S. Food and Drug Administration approval for use in clinical laboratories. The use of these commercial protein databases to accurately identify genus and species of common organisms is at least comparable to conventional typing methods. However, the use of these commercial protein databases will not distinguish strains. Furthermore, the use of commercial protein databases often fails to discriminate between similar species and closely related organisms.

It is well known in the art that methods of applying databases for identification of microorganisms by Matrix Assisted Laser Desorption Ionization Time-Of-Flight (MALDI TOF) mass spectrometry have significant limitations. A first step in a method to identify microorganisms is to acquire mass spectra using MALDI/TOF mass spectrometry. Ions are generated in MALDI-TOF by illuminating a sample with a laser source. Prior art laser repetition rates were often limited to 50 Hz or less and a small number of laser shots (typically 50-500) were summed to produce a spectrum. Laser shots were acquired by looking for “sweet spots” on the MALDI samples. One limitation is that with samples deposited on a spot with a nominal diameter of ca. 3 mm, only a small fraction (typically less than 1%) of the sample molecules were ionized and analyzed. Only a small fraction of the information available from the mass spectra then is typically used by the database. Also, in these prior art methods, it has been determined that both the mass and the intensity of the peaks in a MALDI-TOF mass spectrum are not reproducible.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a flow chart of a method of generating an improved database according to the present teaching.

FIG. 2 illustrates a flow chart of a method of MALDI/TOF mass spectra analysis for identifying organisms according to the present teaching.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teaching may be performed in any order and/or simultaneously as long as the teaching remains operable. Furthermore, it should be understood that the apparatus and methods of the present teaching can include any number or all of the described embodiments as long as the teaching remains operable.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The methods of the present teaching can utilize data from any MALDI-TOF mass spectrometer. However, recent developments in MALDI-TOF mass spectrometry, which are described in U.S. Pat. No. 8,735,810, entitled “Time-of-Flight Mass Spectrometer with Ion Source and Ion Detector Electrically Connected,” U.S. patent application Ser. No. 14/462,146, entitled “Ion Optical System for MALDI-TOF Mass Spectrometer,” and U.S. Provisional Application Ser. No. 62/139,889, entitled “Mass Spectrometry Method and Apparatus for Clinical Diagnostic Applications,” produce MALDI-TOF mass spectra wherein both the intensity and the mass of peaks in the spectra are highly reproducible and, therefore, work particularly well with the methods according to the present teaching. U.S. Pat. No. 8,735,810, U.S. patent application Ser. No. 14/462,146, and U.S. Provisional Application Ser. No. 62/139,885 are all assigned to the present assignee and the entire contents of this patent and these patent applications are herein incorporated by reference. High quality MALDI TOF mass spectrometers, incorporating the improvements described in these patent documents effectively reduce variability in results due to instrument imperfections to the point that the effects are negligible in the quality of the results obtained.

The remaining sources of uncontrolled variability are the sample preparation and deposition on the sample plate. These sources of uncontrolled variability are the dominant reasons for variability in resolving power and measured masses and intensities of the peaks in the spectrum. Although high quality MALDI TOF mass spectrometers reduce this variability to some extent, they cannot fully overcome the effects of poor sample preparation.

One aspect of the methods of the present teaching is that the methods can be used with high-quality MALDI TOF mass spectrometers to further improve and refine the quality of the analysis and to generate reproducible mass spectra from multiple instruments, with multiple users preparing samples, and from multiple sample preparation methods. In addition, the methods of the present teaching provide mass spectra with no significant noise. Furthermore, the methods of the present teaching minimize effects due to variations in the amount and distribution of samples on the sample plate. To achieve these advantages, the methods of the present teaching use advanced sampling techniques and advanced signal and spectra processing techniques.

Another aspect of the methods of the present teaching is that they can reliably identify genus and species and, in some cases, the subspecies and the strain. In addition, the methods of the present teaching can provide practical, fast, and reliable detection and identification of clinically relevant species and strains for application to diagnosis and treatment of disease. More specifically, the methods of the present teaching can provide reproducible MALDI mass spectra from complex samples, assemble a database from such spectra, and search databases to provide reliable identification of genus, species, and strain for a large number of microorganisms.

The methods of the present teaching also improve the identification of various isolates with an improved database that is used to interpret acquired spectra. For the purpose of illustrating the invention, the following descriptions are based on an example focused on protein profiles. Other applications, such as lipid or fatty acid profiles, will be clear to those familiar with the state-of-the-art of identifying micro-organisms using MALDI-TOF spectroscopy. These other applications require using various additional isolates and creating appropriate associated databases.

One embodiment of the methods of the present teaching identifies microorganisms by creating and applying an improved database for protein profiles generated by MALDI-TOF mass spectrometry. For example, for pathogens, we have found that the masses obtained are often sufficiently accurate that individual species and strains can be reliably identified by searching an appropriate DNA database. The masses that correspond to those predicted by the DNA data can then be used to internally recalibrate the spectrum and many additional peaks may be identified as additional proteins or as variant or chemically modified versions of the identified proteins.

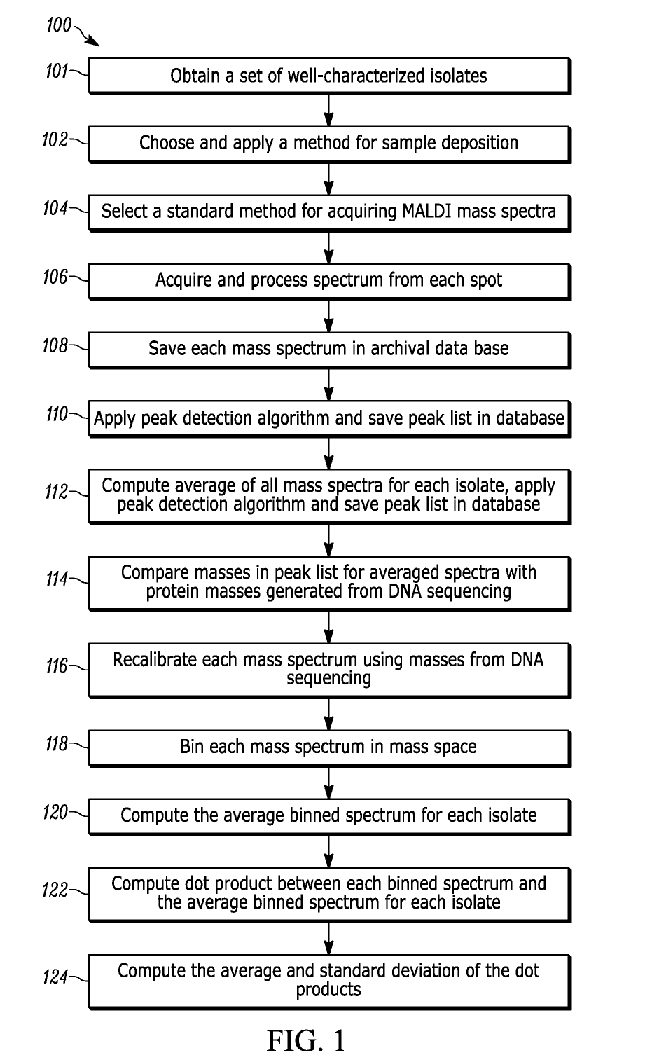

FIG. 1 illustrates a flow chart of a method 100 of generating an improved database according to the present teaching. The first step 101 of the method 100 of generating the improved database is to obtain a set of well-characterized isolates. A second step 102 is to choose and apply a method for depositing samples of the isolate with MALDI matrix onto a MALDI sample plate and applying the samples onto multiple spots on a MALDI sample plate. A third step 104 is to select a standard method to be employed in acquiring MALDI mass spectra from these samples. A fourth step 106 is to acquire and process a mass spectrum from each sample spot. A fifth step 108 is to save each full mass spectrum after processing. A sixth step 110 is to apply a peak detection algorithm to each of the mass spectra and to save the peak list comprising mass, amplitude, area, and signal-to-noise ratio (S/N) for each peak detected.

A seventh step 112 is to compute an average of all of the mass spectra acquired for each isolate, apply the peak detection algorithm, and save the peak list comprising mass, amplitude, area, and signal-to-noise ratio (S/N) for each peak detected. An eighth step 114 is to compare the masses in the peak list for each averaged spectrum to masses generated from DNA sequencing of isolates. A ninth step 116 is to recalibrate each mass spectrum using peaks matched from DNA sequencing of isolates and to generate and store a recalibrated peak list for each mass spectrum. A tenth step 118 is to bin each mass spectrum in mass space with intensity calculated from either peak area or signal-to-noise ratio. In an eleventh step 120, the average of the binned spectra is computed for each isolate. In a twelfth step 122, the binned spectra are normalized and the dot product between each binned spectrum and the average of the binned spectra is then computed for each isolate in the database. In a final step 124, the average and standard deviation of these dot products is computed for each isolate and stored.

The information from the mass spectra is archived, but not included in the final database for searching. The archived information can include the full mass spectrum after processing, mass-to-charge ratio, peak height, intensity, signal-to-noise ratio, total ion current, number of laser shots, spectrum of peaks matched from DNA in mzml format, full mass spectrum recalibrated using peaks matched from DNA, spectrum in mzml format for searching existing database, and binned spectrum.

The various steps of method 100 of FIG. 1 that generate an improved database are now described in more detail. In the first step 101, a library of well-characterized isolates of samples of interest is assembled. Many sources of well-characterized isolates are known in the art. One example of a source for such isolates is the American Type Culture Collection (ATCC). This microorganism collection includes a collection of more than 18,000 strains of bacteria from 900 genera, as well as 2,000 different types of animal viruses and 1,000 plant viruses. In addition, ATCC maintains collections of protozoans, yeasts, and fungi with over 49,000 yeast and fungi strains from 1,500 genera and 2,000 strains of protists. The ATCC number links the isolate to the known information about the isolate and this identification number is included in the metadata saved with mass spectra for each isolate. In addition, the metadata may include the following: date; time; instrument number; operator; sample preparation information; growth media; plate number; spot number.

The second step 102 of the method 100 for generating the improved database involves choosing and applying a method for depositing samples of the isolate with MALDI matrix onto a MALDI sample plate. Many methods for preparing and depositing the sample and matrix onto a MALDI sample plate are known in the art. In one embodiment, the second step 102 involves preparing samples by direct deposition of colonies onto the MALDI plate. In other embodiments, the second step 102 includes preparing samples by depositing aliquots from liquid suspensions. In both these embodiments, MALDI matrix may be added either before or after sample deposition on the plate. The method employed in the second step 102 for sample deposition is included in the metadata recorded for each isolate, and in some cases the method for sample deposition may be modified or optimized based on this information.

In the third step 104 of the method 100 for generating an improved database of the present teaching, conditions for acquiring spectra are chosen according to the requirements of the application. In one embodiment, spectra are acquired over the mass range 2-40 kDa by rastering over a sample spot at 200 μm intervals, with a sample transition speed of 1 mm/s and with laser operating with a repetition rate of a greater than 1 kHz in some methods. Individual spectra of a relatively small number of laser shots, for example 50 laser shots are averaged per spectrum and then stored if a peak with amplitude greater than 0.02 V is detected. The laser fluence may be set at 6 μj and the detector gain may be set for an average amplitude of 0.05V for a single ion in certain instances.

In this embodiment of the method, all of the 50 shot spectra that exceed the 0.02 V threshold are used for averaging. Scanning over a sample spot that has a 3 mm diameter yields an averaged spectrum corresponding to approximately 15,000 shots/sample spot in 15 seconds per spot. Of the spectra acquired, the number of shots stored is typically 5-10,000 shots depending how the sample is distributed on the sample spot. To compensate for poor quality samples and poor quality sample preparation, the measurement time can be automatically adjusted to produce a minimum number of shots saved and a minimal acceptable Total Ion Current (TIC). The acceptable minimum number of laser shots stored and the minimum total ion current will be determined by analyzing the data produced in developing the new database.

If sample preparation is the bottleneck that limits throughput, then the precision of the data can be improved by summing more laser shots per spectrum. For example, a sample spot 2.6 mm in diameter can be rastered at 100 μm intervals and a translation speed of 1 mm/sec. These parameters correspond to a time per sample of approximately one minute. At a laser rate of 1 kHz, 60,000 laser shots are summed. At a laser rate of 5 kHz, the translation speed can be increased to 5 mm/s and the same number of shots are summed in 12 seconds.

These stored spectra are summed or averaged over the sample spot, and these averaged spectra are processed to produce the final spectrum for a sample spot. This averaging approach effectively reduces the large fluctuations in ion intensity as a function of position of the laser spot on the plate. The large fluctuations arise because MALDI samples distributed on a sample plate cause ion intensity to vary as a function of position of the laser spot on the plate, depending on the size and distribution of matrix crystals on the plate, and irregularities in the distribution of the sample.

The correct calibration of the mass scale is important to the accuracy of the results. The mass spectrometer is calibrated by analyzing samples that produce peaks of known mass to produce a default calibration method that is stored in the instrument control system. Under normal operating conditions, the default calibration is generally stable. This calibration can be checked and verified using a reference standard such as E coli. A complete calibration check using 14 reference peaks should give a maximum RMS error of 2 Da. If larger deviations are observed, it may be necessary to recalibrate and update the calibration.

In the fourth step 106 of the method 100 for generating an improved database of the present teaching, the MALDI TOF mass spectra are acquired and processed on multiple sample spots for each isolate. A MALDI-TOF instrument operating at kHz laser repetition rates allows high quality spectra to be generated much more rapidly and efficiently than with the prior art methods. Using a laser repetition rate of 1 kHz, the time required to produce spectra on a single sample spot is about 15 seconds using 200 μm raster at 2 mm/s. With this laser repetition rate, a complete plate in one format including 96 samples and 4 QC spots for a total of 100 spectra requires a total measurement time of 1,500 second or 25 minutes. Thus, a single instrument working an eight hour shift can analyze 19 plates provided the samples can be prepared and spotted. Thus, the time to measure six spectra on 10,000 isolates requires 32 days. If the instrument were operated 24/7, which is possible with an autoloader and robotic sample preparation, then this time can be reduced to less than eight days. Operating at a laser repetition rate of 5 kHz, these times are reduced to 6.4 and 1.6 days, respectively, provided that sample preparation time is not limiting the throughput.

In the fifth step 108 of the method 100 for generating an improved database of the present teaching, each of the mass spectra generated in the fourth step 106 is stored in an archive, but not included in the final database for searching. The archived information includes the full mass spectrum after processing including the nominal number of ions detected in each bin of the digitizer, total ion current, number of laser shots averaged, and the metadata. In one embodiment the number of digitizer bins is more than 50,000.

In the sixth step 110 of the method 100 for generating an improved database of the present teaching, a peak detection algorithm is applied to generate a peak list including mass and intensity for peaks detected in each spectrum acquired and stored in the archival database. The sixth step 110 can use various methods of peak detection known in the art. The Wavelet Transform Method works well with the complex spectra addressed in the methods of the present teaching. See, for example, Du P, Kibbe W A, and Lin S M, “Peak Detection of Mass Spectrometry Spectrum by Continuous Wavelet Transform based Pattern Matching,” (2006) Bioinformatics, 22, 2059-2065. Peak detection algorithms typically identify peaks based on amplitude alone. However, mass spectra peaks have characteristic shapes that provide more information that can be used to improve their identification. The wavelet method is advantageous because it utilizes a shape-matching function that provides a “goodness of fit” coefficient useful for augmenting peak identification. One feature of the wavelet method is that it provides enhanced identification of peaks with different scales and amplitudes. Another feature of the wavelet method is that it provides better separation of the signal from spike noise and colored noise, which enhances the effective signal-to-noise ratio.

Another feature of wavelet transforms is that they can accurately determine peak centroids, even when the peaks are only partially resolved. The result is that the wavelet transform method reliably produces a realistic determination of the signal-to-noise ratio (S/N) for each peak detected. If the signal-to-noise ratio is determined by ion statistics, then the signal-to-noise ratio is equal to the square root of the number of ions in the peak. In the wavelet method, the signal-to-noise ratio is determined directly from the measured spectrum and does not depend on gain of the detector or normalization of the spectra. Thus, the wavelet transform method is advantageous because it does not rely on direct determination of the number of ions in the peak. Direct determination is undesirable because it requires accurate calibration of the gain of the detector which, in practice, is often difficult to accomplish.

Using the wavelet transform method, the square of signal-to-noise ratio can be used as the best measure of intensity of a peak in the spectrum. At a signal-to-noise ratio equal to three, the probability that the peak is statistically different from the noise is about 95%. Thus, if we accept only peaks with signal-to-noise ratio greater than 3, then we can be confident that noise on the spectrum is not significantly represented as peaks. In a complex spectrum covering the mass range of 2 kDa to 40 kDa, the number of peaks detected with a signal-to-noise ratio greater than three is often less than 200. Thus, when using wavelet transforms for peak detection according to the present teaching, the array size can be reduced from 50,000 or more to 200 or less.

In the seventh step 112 of the method 100 for generating an improved database of the present teaching, the average complete mass spectrum in time domain for each isolate is computed, a peak detection algorithm is applied, and the peak list from each averaged spectrum is stored in the searchable database. This step employs the same peak detection algorithm as described above in connection with the sixth step 110.

In the eighth step 114 of the method 100 for generating an improved database of the present teaching, the mass list generated in the seventh step 112 is compared with protein masses determined from searching and interpreting DNA databases. Methods are known in the art for interpreting DNA sequences to determine masses of proteins expressed by specific organisms. For many organisms, it is well-known that ribosomal proteins are often expressed at high levels. Most ribosomal protein subunits are expressed at a 1:1 stoichiometry in the fundamental protein translation particle, the ribosome. Many ribosomal proteins have low molecular weights, and are often highly positively charged, both of which make them readily detectable by MALDI. The approximate molecular weight of most ribosomal proteins is conserved across all bacteria, and the 70 or so ribosomal protein subunits can be readily identified by homology from DNA sequences of any bacterial species by commonly used bioinformatic tools. Ribosomal proteins tend to be encoded together in a small number of clusters on the bacterial chromosome. The sequences of ribosomal protein subunits tend to be relatively invariant within bacterial species, yet in many cases, there are conserved substitutions in ribosomal subunits that distinguish bacterial generally. Many species can be segregated into smaller groupings based on polymorphisms in any ribosomal proteins. A useful taxonomic category consists of all known organisms that share the exact same set of ribosomal protein sequences, which are defined herein as the Clade of Ribosomal Proteins (CORP). In some cases, certain collections of organisms that appear by other criteria to be distinct species belong to the same CORP. In many other cases, species can be differentiated into subspecies groupings based on CORP differences. MALDI mass spectrometry can distinguish between many CORPs, regardless of whether these CORPs correspond to species as they have been defined so far. Of course, many other proteins than ribosomal proteins can also be detected by mass spectrometry and, therefore some CORPs can be differentiated further. Isolates from supposedly distinct species that share the same CORP may be difficult to distinguish by MALDI, and some of them are probably incorrectly annotated.

Many bioinformatic databases are known in the art that provide protein masses from interpretation of DNA sequences. One of these, the TrEMBL database, contains nearly complete proteomes of about 10,000 bacterial isolates and is well annotated regarding ribosomal protein subunits. Each organism is mapped to a taxonomic tree containing the latest knowledge regarding the exact position of the organism within the major taxonomic divisions of bacteria. Thus, even though the complete DNA sequence may not be available for a particular isolate, it is likely to be sufficiently homologous to a species or genus that is represented, that at least some of the ribosomal protein masses will be matched.

In the ninth step 116 of the method 100 for generating an improved database of the present teaching, the mass scale is recalibrated for the averaged complete mass spectra for each isolate by matching observed peaks to masses matched from DNA database and the recalibrated peak list are stored in the searchable database. The list of peaks matched within some maximum error generates a calibration file of protein masses that can be used to recalibrate the spectrum and to test the spectrum for internal consistency. If the match is correct, recalibration will reduce the error for the peaks matched and increase the number of peaks matched. If the match is not correct, the recalibration is discarded. In some embodiments of the method, the ninth step 116 recalibrates the mass scale for each mass spectrum from each isolate using calibration parameters determined in the eighth step 114 and generates a corrected mass list for each spectrum. If recalibration in step nine 116 is successful in reducing the mass error, then the calibration parameters determined in step nine 116 are applied to recalibration of the spectra generated for that isolate.

In the tenth step 118 of the method 100 for generating an improved database of the present teaching, each spectrum is binned in mass space. The proper bin width to avoid jitter is determined by the uncertainty in mass. One characteristic of the mass spectra is that the uncertainty, ω, in mass is proportional to the mass, m. To avoid jitter in assigning peaks to bins, the width of the bin should be substantially larger than the mass uncertainty, but small enough to distinguish peaks that are clearly different.

For linear MALDI, the uncertainty due to the characteristics of the instrument is generally less than 100 ppm, but larger uncertainties may be due to variations in the sample thickness and distribution on the sample plate. We have observed that the uncertainty in mass may be as large as 500 ppm for microorganisms where a sample from a culture is deposited directly on the sample plate with added matrix solution. One aspect of the present teaching is that it has been determined that a bin width in the range 1000-2000 ppm is often satisfactory. However, the optimum bin width needs to be empirically determined. One downside of binning is that peaks with mass approximately equal to the boundary between bins may be found in either bin.

Equations for assigning the bin as a function of mass are as follows:

m(i)=mₘᵢₙ(1+w)ⁱ⁻¹;

where “i” is the bin number and “w” is the width of the bin in ppm.

mₘₐₓ=mₘᵢₙ(1+w)^{q-1};

where q is the total number of bins,

log₁₀(mₘₐₓ/mₘᵢₙ=(q−1)log₁₀(1+w),

and this can be solved for q for any values of mₘₐₓ, mₘᵢₙ, and w, where the width w=1/R where R is the nominal resolving power.

i(m)=1+log₁₀(m/mₘᵢₙ)/log₁₀(1+w);

q=1+log₁₀(mₘₐₓ/mₘᵢₙ)/log₁₀(1+w);

Thus, if mₘᵢₙ=2,000 Da, mₘₐₓ=19,900, w=1,000 ppm=0.001, then q=2,300 bins. If mₘᵢₙ=2,000 Da, mₘₐₓ=20,300, w=1,786 ppm=0.001786, then q=1,300 bins. If mₘᵢₙ=2,000 Da, mₘₐₓ=40,000, w=2,000 ppm=0.002, then q=1,500 bins.

The intensity associated with each bin can be calculated from the experimental determined intensity for the sum of peaks assigned to a bin. Prior art methods use an intensity of unity for a peak in a bin and zero for no peak in the bin. These prior art methods assign too little weight to the large peaks. Using linear intensities may assign too much weight to the more intense peaks resulting in the peaks of lower intensity having too little weight. Some methods of the present teaching use peak intensity calculated from the signal-to-noise ratio, either as log₁₀[2Sᵢ(j)] or [Sᵢ(j)]². Thus, the amplitude of a particular bin is given by Nᵢ(j)=log₁₀[2Sᵢ(j)] or [Sᵢ(j)]² where i is the bin index and j is the index of a spectrum and Nᵢ(j) is the intensity.

One of the problems with binning is that some masses may correspond closely to the mass limit of a bin. A small variation in measured mass may then cause the mass peak to move from one bin to another. Thus, some embodiments of the present teaching generate a second binning in which the lower mass limit of a bin is given by

mₒ(i)=mₘᵢₙ(1+w/2)(1+w)ⁱ⁻¹;

where i is the bin number and w is the width. With this second binning, peaks that were at the bin divider are shifted to the center of the bin, and peaks that were in the center of the bin are moved to the bin divider. The average of the dot products using these two binning methods can then be used for computing the probability of matches.

In the eleventh step 120 of the method 100 for generating an improved database of the present teaching, each binned spectrum is normalized to represent a unit vector in binned mass space. After each spectrum is binned in mass space, the data is processed to convert the spectrum to a multi-dimensional vector. The mass axis is converted to bin numbers that corresponds to a particular component of the vector. The intensities may be normalized to convert the spectrum into a vector of nominal length. Then, the average of the binned spectra for each isolate is computed.

The relation between bin number i and mass m for a bin is given by:

i(m)=1+log₁₀(m/mₘᵢₙ)/log₁₀(1+w).

In one embodiment, the intensity in bin i of spectrum j corresponding to isolate k is given by:

Nᵢ(j,k)=[Sᵢ(j,k)]²;

where i is the bin index and Sᵢ(j,k) is the signal-to-noise ratio of a peak in bin i. If more than one peak is assigned to a particular bin, then the intensity is the sum of the intensities of the peaks in that bin. The binned spectra are normalized to correspond to components ni(j,k) of a vector of unit magnitude in q-dimensional space.

nᵢ(j,k)=Nᵢ(j,k)/[ΣᵢNᵢ(j,k)²]^{1/2}

The average of the binned spectra j for isolate k is given by

Bᵢ(k)=[ΣⱼNᵢ(j,k)]/C(k);

where C(k) is number of spectra for isolate k, and the normalized spectrum is given by:

bᵢ(k)=Bᵢ(k)/[ΣᵢBᵢ(k)²]^{1/2}

In the twelfth step 122 of the method 100 for generating an improved database of the present teaching, the dot product is computed between the normalized vector for each spectrum corresponding to a particular isolate and the average normalized vector for that isolate. The dot product of the normalized vector for each spectrum j from isolate k with the average normalized vector for each isolate k in the database is given by:

p(j,k)=Σᵢ[nᵢ(j,k)bᵢ(k).

In the final step 124 of the method 100 for generating an improved database of the present teaching, the average and the standard deviation of the dot products for the spectra for isolate k are computed. The average of the p(j,k) is:

aₖ=Σⱼ[p(j,k)]/C(k),

and the standard deviation is:

sₖ={Σⱼ[aₖ−p(j,k)]²/C(k)}^{1/2} where C(k) is the number of spectra generated for isolate k.

The average and the standard deviation of the dot products for each isolate are stored in the searchable database. In addition, the peak list from the averaged spectrum and the average binned spectrum for each isolate are stored in the searchable database along with the metadata. In some applications, reliable DNA sequence data may not be available, and steps eight, nine and ten may be omitted. In some embodiments, the average binned spectrum for each isolate is calculated by averaging the binned spectra generated for each spectrum for the isolate, and in other embodiments, the averaged binned spectrum is calculated by binning the average spectrum for each isolate.

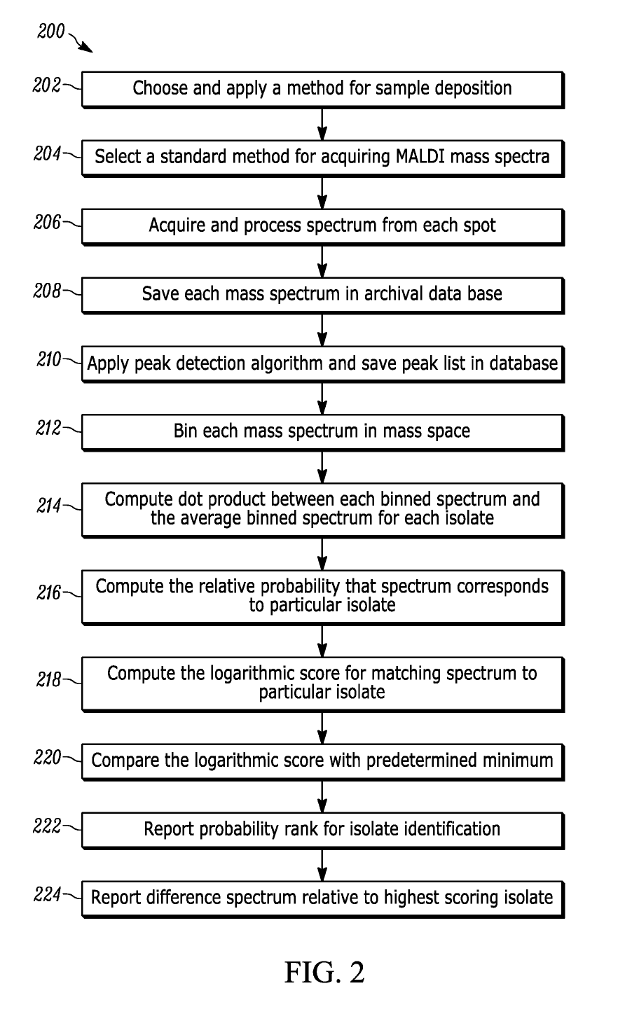

One feature of the methods of the present teaching is that the methods improve the identification of organisms using MALDI-TOF mass spectrometry. FIG. 2 illustrates a flow chart of a method 200 of MALDI/TOF mass spectra analysis for identifying organisms according to the present teaching. The first five steps in a method for identifying organisms according to the present teaching are similar to the second through the sixth step in the method for generating the database described in connection with FIG. 1. Referring to FIGS. 1 and 2, in a first step 202 of the method 200 for identifying organisms according to the present teaching, a method is chosen for depositing samples of the isolate with MALDI matrix onto a MALDI sample plate and applying the samples onto at least one spot on a MALDI sample plate. A second step 204 is to select a standard method to be employed in acquiring MALDI mass spectra. A third step 206 is to acquire and process a mass spectrum from each sample spot. A fourth step 208 is to save each full mass spectrum after processing. A fifth step 210 is to apply a peak detection algorithm to each of the mass spectra and to save the peak list comprising mass, amplitude, area, and signal-to-noise ratio (S/N) for each peak detected.

In a sixth step 212, each spectrum is binned in mass space using the same binning method and parameters employed in the tenth step 120 for generating the database as described in connection with FIG. 1. The dot product between each binned spectrum and the average binned spectrum for each isolate k in the database is then computed in a seventh step 214. The dot product between the mass spectrum s and the average for each isolate k is given by:

p(s,k)=Σᵢ[nᵢ(s)bᵢ(k)]=pₛ(k) where nᵢ(s)=Nᵢ(s)/[ΣNₗ(s)²]^{1/2}

Then, the relative probability that each spectrum corresponds to a particular isolate k is computed in an eighth step 216. The relative probability that spectrum s corresponds to isolate k is given by:

f(s,k)=exp−{[pₛ(k)−a^{k}]²/2σₖ²}

where aₖ, σₖ is from the database.
Converting to percent, the reported probability is then 100*f(s,k).

The logarithmic score for matching a spectrum to an isolate is then computed in a ninth step 218. The score for the matching spectrum s to isolate k can be expressed as:

Score=−Log₁₀{1−f(s,k)}.

The logarithmic score is then compared with a predetermined minimum score for a match in a tenth step 220. Determining the appropriate predetermined minimum score or threshold requires evaluation of the data generated in the initial studies. The discrimination, however, is much higher than that obtained using prior art methods. A first estimate suggests that the following criteria may be appropriate if enough spectra for each isolate have been generated: (1) a score threshold below 0.7 is rejected (80% probability); and (2) maximum number of isolates with scores greater than a threshold equal to 4 corresponding to cases where the discriminating power is low. An isolate is identified with particular spectra when the threshold has been exceeded in the comparison.

In an eleventh step 222, if more than one isolate passes the score threshold, then the reported probability for each is divided by the sum of the probabilities for those passing the score threshold. The report of probability rank for identification of isolate k by spectrum s is given by:

PR(s,k)=100f(s,k)/Σₓf(s,kₓ);

where the summation is over all isolates x satisfying the score threshold. In a final step 224, the difference between the mass spectrum and the highest scoring isolate is computed and reported. The resulting difference spectrum Dᵢ(s,k)=[Nᵢ(s)−Bᵢ(k)] can then be used to determine the peaks that are different from the average.

Another aspect of the method of the present teaching is that some embodiments allow for isolates to be sorted into strains. In these embodiments, when a version of the database is completed with at least ten (and preferably more) spectra acquired for each isolate included, the database will include an average spectrum and the distribution (mean and standard deviation) of dot products of the individual spectrum with the average for that isolate. In some embodiments, the individual spectra are not stored. The similarity and differences between individual isolates can be determined by calculating both the dot product between each pair of isolates of a species and the difference spectrum for each pair.

The probability that the isolates represent the same strain of a species can be determined by calculating the joint probability based on the mean and standard deviation for each. The difference spectrum will show in detail which peaks are distinctly different. It may be possible to determine if the difference spectrum is due to real genetic differences or if this is a product of different growth conditions or sample preparation. If sets of isolates are found to be identical within a predetermined confidence level, these isolates can be combined into a single strain for future applications of the database.

Another feature of the methods of the present teaching is that, by assessing the similarities and difference among the isolates, it may be possible to sort them into specific strains. Searching the DNA database often identifies a number of isolates that are indistinguishable based on ribosomal protein subunits (CORPs). Many of these isolates may not be represented in the set of isolates used to generate the spectrum database. In some cases, these isolates may, in fact, not be distinct organisms, but rather represent a diversity in the naming of isolates. After the initial work in generating a new database for a defined set of isolates, for example by using the method 100 described in connection with FIG. 1, it should be possible to determine which of the isolates represent a diversity in naming, and which of the isolates are actually distinct. Distinct isolates can be determined by calculating the dot product of the binned average spectrum for each isolate with each of the other binned average spectra for isolates in the protein database. The relative probability that isolates are indistinguishable (and possibly identical) can be computed by the dot product:

p(j,k)=[Σᵢbᵢ(j)bᵢ(k)];

PR(j,k)=100 exp−{[1−p(j,k)]²/2(σⱼ²+σₖ²)}.

If PR(j,k) is greater than some threshold (ca 99), the spectra may be considered identical and merged into a single strain with multiple identifications.

It is understood that there is a dependence of the protein profile spectra on various factors, such as the sample preparation method, growth medium, and factors other than the mass spectrometer and the properties of the organism that may affect the observed protein profiles. This dependence can be overcome by measurement on a few selected isolates of different types of microorganisms and comparing results obtained by systematically changing these parameters. For example, one of the parameters is the difference between samples prepared by direct deposition of colonies on the MALDI plate and those prepared by depositing aliquots from liquid suspensions.

All of the entries in the database are identified as a particular genus, species, and strain. In some cases, acceptable scores may be obtained for multiple entries in the database, indicating that these strains cannot be accurately differentiated from the spectrum provided, but if all of the matches correspond to the same species or genus, then the probability rank that the spectrum corresponds to species (or genus) x is given by:

PR(s,x)=100Σₖf(s,kₓ)/{Σₖf(s,kₓ)+Σₖf(s,k_{q})};

where kₓ is all of the isolates of species (or genus x) satisfying the score threshold and k_{q} are all of the isolates of other species or genus satisfying the score threshold. Alternatively, the identification of strains can be suppressed by computing the average of the binned spectra j for each species (or genus) x given by:

Bᵢ(m)=[ΣⱼNᵢ(j,m)]/C(m);

where C(m) is number of spectra for species (or genus) m, and the normalized spectrum is given by:

bᵢ(m)=Bᵢ(m)/[ΣᵢBᵢ(m)²]^{1/2}.

The procedures for generating and searching the database are otherwise unchanged and the results are limited to identification of the species (or genus).

Another aspect of the methods of the present teaching is that microorganisms can be identified by creating and applying an improved database for lipid profiles generated by MALDI-TOF mass spectrometry. In one embodiment, lipids extracted from samples of interest are converted into fatty acids employing various techniques known in the art and the resulting fatty acid profiles are generated by negative ion mass spectrometry. The method 100 described in connection with FIG. 1 can be used to generate the improved database for this embodiment.

### Equivalents

While the Applicant's teaching are described in conjunction with various embodiments, it is not intended that the applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A method for generating a searchable database for organism identification using Matrix Assisted Laser Desorption Ionization Time-Of-Flight (MALDI TOF) mass spectrometry, the method comprising:
a) acquiring a plurality of mass spectra data from samples of isolates of well-characterized organisms using MALDI TOF mass spectrometry;
b) performing peak detection of the acquired mass spectra data to generate peak detected spectral data of the isolates for the well-characterized organisms;
c) averaging the acquired mass spectra data;
d) performing peak detection of the averaged mass spectra data to generate peak detected averaged spectral data of the isolates for the well-characterized organisms;
e) binning the acquired mass spectra data and generating a plurality of vectors, where n is a number of bins used to determine the binned mass spectrum;
f) computing an average binned spectrum of the isolates for the well-characterized organisms;
g) computing dot products between the binned acquired mass spectra data and the averaged binned spectrum of the isolates for the well-characterized organisms;
h) computing an average and a standard deviation of the dot products between the binned acquired mass spectra data and the averaged binned spectrum of the isolates for the well-characterized organisms; and
i) creating a searchable database of the averaged mass spectra data, peak detected average mass spectra, average and standard deviation of the dot products between the binned acquired mass spectra data and the averaged binned spectrum of the isolates for the well-characterized organisms.

2. The method of generating a searchable database of claim 1 further comprising selecting a method of MALDI sample deposition.

3. The method of generating a searchable database of claim 1 wherein the searchable database is structured to include metadata for each well-characterized organism.

4. The method of generating a searchable database of claim 3 wherein the metadata comprises at least one of isolate identification, date, time, instrument number, operator, sample preparation information, growth media, plate number, spot number, and operator comments.

5. The method of generating a searchable database of claim 1 further comprising comparing the peak detected averaged spectral data for the well-characterized organisms with protein masses calculated from genomic DNA sequences.

6. The method of generating a searchable database of claim 5 further comprising recalibrating the mass spectra using protein masses calculated from genomic DNA sequences.

7. The method of generating a searchable database of claim 1 wherein performing peak detection of the acquired mass spectra data comprises performing a wavelet transform that produces a signal-to-noise ratio for each peak detected.

8. The method of generating a searchable database of claim 7 wherein the performing the wavelet transform further comprises using peak intensity calculated from the signal-to-noise ratio.

9. A method for organism identification using Matrix Assisted Laser Desorption Ionization Time-Of-Flight (MALDI TOF) mass spectrometry, the method comprising:
a) generating a searchable database for organism identification using MALDI TOF mass spectrometry;
b) acquiring a mass spectrum from a sample using MALDI TOF mass spectrometry;
c) performing peak detection of the acquired mass spectrum;
d) binning the peak detected mass spectrum and generating a vector in n-dimensional space, where n is a number of bins used to determine the binned mass spectrum;
e) computing dot products between the generated vector of the binned peak detected mass spectrum and an averaged binned spectrum for each isolate in the searchable database;
f) computing a relative probability that the acquired mass spectrum matches a mass spectrum from each isolate in the searchable database;
g) computing a logarithmic score for matching the acquired mass spectrum with the mass spectrum from each isolate in the searchable database;
h) comparing the logarithmic score for matching the acquired mass spectrum with the mass spectrum from each isolate in the searchable database to a predetermined minimum passing score and generating a list of passing score isolates with greater than the predetermined minimum passing score;
i) generating a probability rank for each passing score isolate using the list of passing score isolates; and
j) reporting the probability rank for each passing score isolate and the logarithmic score for each passing score isolate.

10. The method of organism identification of claim 9 wherein the generating the searchable database comprises:
a) acquiring a plurality of mass spectra from samples of isolates of well-characterized organisms using MALDI TOF mass spectrometry;
b) performing peak detection of the acquiring mass spectra data to generate peak detected spectral data of the isolates of well-characterized organisms;
c) averaging the acquired mass spectra data;
d) performing peak detection of the averaged mass spectra data to generate peak detected averaged spectral data of the isolates of well-characterized organisms;
e) binning the acquired mass spectra data and generating a plurality of vectors, where n is a number of bins used to determine the binned mass spectrum;
f) computing an average binned spectra of the isolates of well-characterized organisms;
g) computing dot products between the binned acquired mass spectra data and the averaged binned spectrum of the isolates of well-characterized organisms;
h) computing an average and a standard deviation of the dot products between the binned acquired mass spectra data and the averaged binned spectrum of the isolates for the well-characterized organisms; and
i) creating a searchable database of the averaged mass spectra data, peak detected average mass spectra data, average and standard deviation of the dot products between the binned acquired mass spectra data and the averaged binned spectrum of the isolates for the well-characterized organisms.

11. The method of organism identification of claim 9 further comprising recalibrating at least some of the plurality of mass spectra by comparing masses that correspond to those deduced from DNA data.

12. The method of organism identification of claim 9 wherein the searchable database is structured to include metadata for each well-characterized organism.

13. The method of organism identification of claim 12 wherein the metadata comprises at least one of isolate identification, date, time, instrument number, operator, sample preparation information, growth media, plate number, spot number, and operator comments.

14. The method of organism identification of claim 13 wherein isolate identification comprises an ATCC number or other identification that links the isolate to the known information about the isolate.

15. The method of organism identification of claim 9 further comprising matching detected peaks to a set of masses of ribosomal proteins calculated from genomic DNA sequences shared by any taxonomic clade.

16. The method of organism identification of claim 9 wherein the acquiring a mass spectrum from a sample using MALDI TOF mass spectrometry comprises storing those spectra that exceed a predetermined intensity and then averaging them over a sample spot.

17. The method of organism identification of claim 9 wherein the performing peak detection of the acquired mass spectra comprises performing a wavelet transform that produces a signal-to-noise ratio for each peak detected.

18. The method of organism identification of claim 17 wherein the performing the wavelet transform further comprises using peak intensity calculated from the signal-to-noise ratio.

19. The method of organism identification of claim 9 wherein the binning the acquired mass spectrum comprises creating bins having a width that is substantially larger than the mass uncertainty, but small enough to distinguish peaks that are different.

20. The method of organism identification of claim 9 further comprising generating a second binning where peaks that were at a bin divider are shifted to a center of the bin, and peaks that were in a center of the bin are moved to the bin divider.

21. The method of organism identification of claim 20 further comprising averaging a dot product of the first and second binning to compute the relative probability that each peak detected averaged mass spectra corresponds to the particular isolate.

22. The method of organism identification of claim 9 wherein the binning the acquired mass spectrum comprises normalizing the vector into a vector of unit length.

23. The method of organism identification of claim 9 wherein the acquiring mass spectra data comprises acquiring mass spectra data with a laser operating with a repetition rate that is equal to or greater than 1 kHz.

24. The method of organism identification of claim 9 wherein the acquiring mass spectra data comprises summing data from at least 10,000 laser shots.
